(19) United States
(12) Patent Application Publication
(10) Pub. No.: US 2022/0412329 A1
(43) Pub. Date: Dec. 29, 2022

(54) ION JET ENGINE SYSTEM AND ASSOCIATED METHOD(S)

(71) Applicant: Ian Harrison, Saint Marys, GA (US)

(72) Inventor: Ian Harrison, Saint Marys, GA (US)

(21) Appl. No.: 17/657,737

(22) Filed: Apr. 1, 2022

Related U.S. Application Data
(60) Provisional application No. 63/169,689, filed on Apr. 1, 2021.

(51) Int. Cl. F03H 1/00; F02K 7/16

(52) U.S. Cl. CPC F03H 1/0031; F02K 7/16; F03H 1/0093; F03H 1/0012

(57) ABSTRACT

An ion jet engine system includes a jet turbine engine having at least one high voltage turbine blade, a microwave emitter in communication with the jet turbine engine, a water tank having stainless steel plates for providing and being in communication with the jet turbine engine, a plasma torch in communication with the water tank, and a plasma chamber in communication with the plasma torch and having diameter spheres that trap and internally reflect microwaves. Advantageously, the jet turbine engine uses plasma from ionizing air, and liquid hydrogen and/or oxygen from electrolyzing water to create thrust.

### CROSS REFERENCE TO RELATED APPLICATIONS

This is a non-provisional patent application that claims priority to and benefit of co-pending U.S. provisional patent application No. 63/169,689 filed Apr. 1, 2021, which is incorporated by reference herein in its entirety.

### STATEMENT REGARDING FEDERALLY SPONSORED RESEARCH OR DEVELOPMENT

Not Applicable.

### REFERENCE TO A MICROFICHE APPENDIX

Not Applicable.

### BACKGROUND

### Technical Field

Exemplary embodiment(s) of the present disclosure relate to ion-propelled engines and, more particularly, to an ion jet engine system that uses plasma from ionizing air, and liquid hydrogen\oxygen from electrolyzing water to create thrust.

### Prior Art

An ion thruster is a form of electric propulsion used for spacecraft propulsion that creates thrust by accelerating ions. The term is used to refer to gridded ion thrusters but may often be applied to all electric propulsion systems that accelerate plasma (electrically neutral medium of positive and negative particles), since plasma includes ions. Ion thrusters are categorized by how they accelerate the ions, using either electrostatic or electromagnetic force. Electrostatic ion thrusters use the Coulomb force (the electric field vector at that point) and accelerate the ions in the direction of the electric field. Electromagnetic ion thrusters use the Lorentz force (the combination of electric and magnetic force on a point charge due to electromagnetic fields) to accelerate the ions.

Ion thrusters use beams of ions (electrically charged atoms or molecules) to create thrust in accordance with momentum conservation. The method of accelerating the ions varies, but all designs take advantage of the charge/mass ratio of the ions. This ratio means that relatively small potential differences can create very high exhaust velocities. This reduces the amount of reaction mass or fuel required, but increases the amount of specific power required, compared to chemical rockets. Ion thrusters are therefore able to achieve extremely high specific impulses. The drawback of the low thrust is low spacecraft acceleration because the mass of current electric power units is directly correlated with the amount of power given. This low thrust makes ion thrusters unsuited for launching spacecraft into orbit, but ideal for in-space propulsion applications.

Accordingly, a need remains for an ion jet engine system in order to overcome at least one of the above-noted shortcomings. The exemplary embodiment(s) satisfy such a need by an ion jet engine system that uses plasma from ionizing air, and liquid hydrogen\oxygen from electrolyzing water that is convenient and easy to use, durable in design, versatile in its applications, and designed to create thrust.

### BRIEF SUMMARY OF NON-LIMITING EXEMPLARY EMBODIMENT(S) OF THE PRESENT DISCLOSURE

In view of the foregoing background, it is therefore an object of the non-limiting exemplary embodiment(s) to provide an ion jet engine system. These and other objects, features, and advantages of the non-limiting exemplary embodiment(s) are provided by an ion jet engine system includes a jet turbine engine having at least one high voltage turbine blade, a microwave emitter 76 in communication with the jet turbine engine, a water tank having stainless steel plates for providing electrolysis and being in communication with the jet turbine engine, a plasma torch in communication with the water tank, and a plasma chamber in communication with the plasma torch and having diameter spheres that trap and internally reflect microwaves. Advantageously, the jet turbine engine uses plasma from ionizing air, and liquid hydrogen and/or oxygen from electrolyzing water to create thrust.

There has thus been outlined, rather broadly, the more important features of non-limiting exemplary embodiment(s) of the present disclosure so that the following detailed description may be better understood, and that the present contribution to the relevant art(s) may be better appreciated. There are additional features of the non-limiting exemplary embodiment(s) of the present disclosure that will be described hereinafter and which will form the subject matter of the claims appended hereto.

### BRIEF DESCRIPTION OF THE NON-LIMITING EXEMPLARY DRAWINGS

The novel features believed to be characteristic of non-limiting exemplary embodiment(s) of the present disclosure are set forth with particularity in the appended claims. The non-limiting exemplary embodiment(s) of the present disclosure itself, however, both as to its organization and method of operation, together with further objects and advantages thereof, may best be understood by reference to the following description taken in connection with the accompanying drawings in which:

FIG. 1 is a schematic diagram of a hydro-booster/electrolysis device employed by the ion jet engine system, in accordance with a non-limiting exemplary embodiment of the present disclosure;

FIG. 2 is a perspective view of a plasma chamber z;

FIG. 3 is another perspective view of the plasma chamber z shown in FIG. 2;

FIG. 4 is a top plan view of a refriger-laser optical cooling system;

FIG. 5 is another top plan view of the refriger-laser optical cooling system shown in FIG. 4 and having metal;

FIG. 5a is another top plan view of the refriger-laser optical cooling system having an intake for oxygen and hydrogen gases and an exhaust for oxygen and hydrogen liquids;

FIG. 5b is another top plan view of the refriger-laser optical cooling system having a wave generator;

FIG. 5c another top plan view of the refriger-laser optical cooling system connected to the ion jet engine via a fuel lien;

FIG. 6 is a top plan view of two coils for transferring hydrogen and oxygen gases;

FIG. 7 is a schematic diagram of the plasma chamber design z;

FIG. 8 is a schematic diagram showing a portion of the ion jet engine system;

FIG. 9 is a perspective view showing an interior of a plasma chamber design v;

FIG. 10 is a perspective view showing the interrelationship between the hydro-booster/electrolysis device, DC power supply, and magnetron;

FIG. 11 is another perspective view showing the interrelationship between select electronic components of the ion jet engine system;

FIG. 12 is another perspective view showing the interrelationship between select electronic components of the ion jet engine system;

FIG. 13 is another perspective view showing the interrelationship between select electronic components of the ion jet engine system;

FIG. 14 are perspective views of a plasma cutter;

FIG. 15 is a perspective view showing the interrelationship between a hydro-booster/electrolysis device, plasma cutter, and the ion jet engine;

FIG. 15a is a perspective view showing the interrelationship between a hydro-booster/electrolysis device, plasma cutter, ion jet engine, and magnetron;

FIG. 15b is a perspective view showing the interrelationship between a hydro-booster/electrolysis device, plasma cutter, ion jet engine, and magnetron placed at a different location;

FIG. 16 is a side elevational view of a plasma cutter nozzle;

FIG. 17 is a top plan view of the refriger-laser/optical cooling tube;

FIG. 17a is a bottom plan view of the refriger-laser/optical cooling tube;

FIG. 17b is a side elevational view of the refriger-laser/optical cooling tube;

FIG. 17c is a side elevational view of the plasma chamber;

FIG. 18 is a front elevational view of the ion jet engine;

FIG. 18a is a side elevational view of the ion jet engine;

FIG. 18b is a top plan view of the ion jet engine;

FIG. 18c is a side elevational view of the plasma chamber design v;

FIG. 18d is a side elevational view of the plasma chamber design y;

FIG. 18e is a side elevational view of the plasma chamber design z;

FIG. 19 is a schematic diagram of the electrolysis machine, gas hose line, and refriger-laser/optical cooling system;

FIG. 20 is a schematic diagram of the refriger-laser/optical cooling system coil;

FIG. 20a is a schematic diagram of the plasma chamber design v;

FIG. 21 is a schematic diagram of the plasma chamber design z;

FIG. 22 is a schematic diagram of an alternative H202 second fuel system (electrolysis device) and adjacent components in communication therewith;

FIG. 23 is a schematic diagram of an exemplary plasma chamber and jet engine design;

FIG. 23a is another schematic diagram of an exemplary plasma chamber and jet engine design;

FIG. 24 are schematic diagrams showing possible optical cooling ring (tube) geometries;

FIG. 25 is a schematic diagram of the conjoined plasma chambers of the jet engine;

FIG. 26 is a side elevational view of the conjoined plasma chambers;

FIG. 27 is a schematic diagram of the supercharged plasma chamber gates/valves;

FIG. 28 is a schematic diagram of the supercharged plasma chamber;

FIG. 28a is a schematic diagram showing compressed air flow of the supercharged plasma chamber;

FIG. 28b is another schematic diagram showing compressed air flow of the supercharged plasma chamber;

FIG. 29 is a schematic diagram of the supercharged plasma chamber;

FIG. 29a is a schematic diagram showing compressed air flow of the supercharged plasma chamber;

FIG. 29b is another schematic diagram showing compressed air flow of the supercharged plasma chamber;

FIG. 30 is another schematic diagram of the supercharged plasma chamber illustrating the supercharger and electric motor/clutch;

FIG. 31 is another schematic diagram showing compressed air flow of the supercharged plasma chamber;

FIG. 32 is schematic diagram of the support struts at the plasma chamber;

FIG. 33 is another schematic diagram showing the interrelationship between the compressors, electric motor/clutch, plasma chamber/exhaust nozzle, and light emission devices of the ion jet engine;

FIG. 34 is a schematic diagram showing the interrelationship between the fan/turbine, electric motor/clutch, and alternator of the ion jet engine;

FIG. 35 is a schematic diagram showing the interrelationship between the electrolysis tank, fluid storage tank and other select components of the ion jet engine system secondary fuel cooling system;

FIG. 36 is another schematic diagram showing the interrelationship between the fuel lines and the electromagnetic cooling device of the secondary fuel cooling system;

FIG. 37 is another schematic diagram showing the interrelationship between the release valves and lines of the main fuel cooling system;

FIG. 38 is another schematic diagram showing the interrelationship between the cooling storage tank, auxiliary coolant lines, coolant lines and auxiliary coolant storage tank of the main fuel cooling system;

FIG. 39 is another schematic diagram showing the interrelationship between the electromagnetic cooling device and select components of the ion jet engine system of the main fuel cooling system;

FIG. 40 is another schematic diagram showing the interrelationship between the pressurized fluid lines, alternator, and decompression chamber of the boiler system; and

FIG. 41 is high level schematic block diagram of the ion jet engine system, in accordance with a non-limiting exemplary embodiment of the present disclosure.

Those skilled in the art will appreciate that the figures are not intended to be drawn to any particular scale; nor are the figures intended to illustrate every non-limiting exemplary embodiment(s) of the present disclosure. The present disclosure is not limited to any particular non-limiting exemplary embodiment(s) depicted in the figures nor the shapes, relative sizes or proportions shown in the figures.

### DETAILED DESCRIPTION OF NON-LIMITING EXEMPLARY EMBODIMENT(S) OF THE PRESENT DISCLOSURE

The present disclosure will now be described more fully hereinafter with reference to the accompanying drawings, in which non-limiting exemplary embodiment(s) of the present disclosure is shown. The present disclosure may, however, be embodied in many different forms and should not be construed as limited to the non-limiting exemplary embodiment(s) set forth herein. Rather, such non-limiting exemplary embodiment(s) are provided so that this application will be thorough and complete, and will fully convey the true spirit and scope of the present disclosure to those skilled in the relevant art(s). Like numbers refer to like elements throughout the figures.

The illustrations of the non-limiting exemplary embodiment(s) described herein are intended to provide a general understanding of the structure of the present disclosure. The illustrations are not intended to serve as a complete description of all of the elements and features of the structures, systems and/or methods described herein. Other non-limiting exemplary embodiment(s) may be apparent to those of ordinary skill in the relevant art(s) upon reviewing the disclosure. Other non-limiting exemplary embodiment(s) may be utilized and derived from the disclosure such that structural, logical substitutions and changes may be made without departing from the true spirit and scope of the present disclosure. Additionally, the illustrations are merely representational are to be regarded as illustrative rather than restrictive.

One or more embodiment(s) of the disclosure may be referred to herein, individually and/or collectively, by the term “non-limiting exemplary embodiment(s)” merely for convenience and without intending to voluntarily limit the true spirit and scope of this application to any particular non-limiting exemplary embodiment(s) or inventive concept. Moreover, although specific embodiment(s) have been illustrated and described herein, it should be appreciated that any subsequent arrangement designed to achieve the same or similar purpose may be substituted for the specific embodiment(s) shown. This disclosure is intended to cover any and all subsequent adaptations or variations of other embodiment(s). Combinations of the above embodiment(s), and other embodiment(s) not specifically described herein, will be apparent to those of skill in the relevant art(s) upon reviewing the description.

References in the specification to “one embodiment(s)”, “an embodiment(s)”, “a preferred embodiment(s)”, “an alternative embodiment(s)” and similar phrases mean that a particular feature, structure, or characteristic described in connection with the embodiment(s) is included in at least an embodiment(s) of the non-limiting exemplary embodiment(s). The appearances of the phrase “non-limiting exemplary embodiment” in various places in the specification are not necessarily all meant to refer to the same embodiment(s).

Directional and/or relationary terms such as, but not limited to, left, right, nadir, apex, top, bottom, vertical, horizontal, back, front and lateral are relative to each other and are dependent on the specific orientation of an applicable element or article, and are used accordingly to aid in the description of the various embodiment(s) and are not necessarily intended to be construed as limiting.

If used herein, “about,” “generally,” and “approximately” mean nearly and in the context of a numerical value or range set forth means ±15% of the numerical.

If used herein, “substantially” means largely if not wholly that which is specified but so close that the difference is insignificant.

A non-limiting exemplary embodiment(s) of the present disclosure is referred to generally in the figures and is intended to provide an ion jet engine system 70 that uses plasma from ionizing air, and liquid hydrogen\oxygen from electrolyzing water to create thrust. It should be understood that the exemplary embodiment(s) may be used to propel a variety of objects and should not be limited to any particular object described herein.

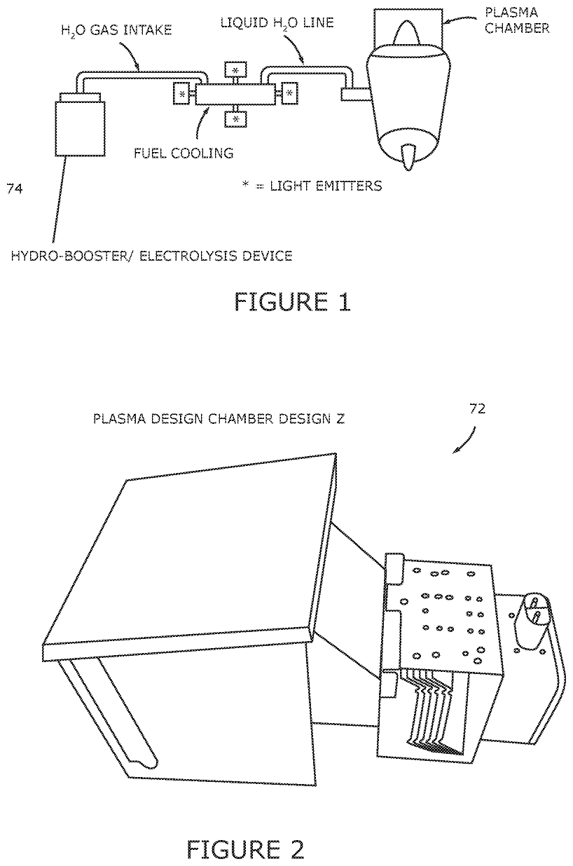

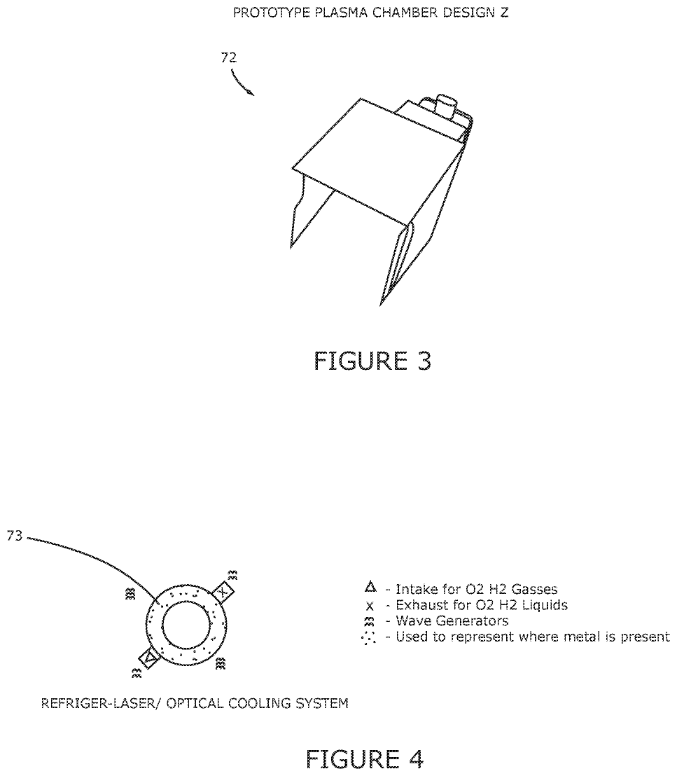

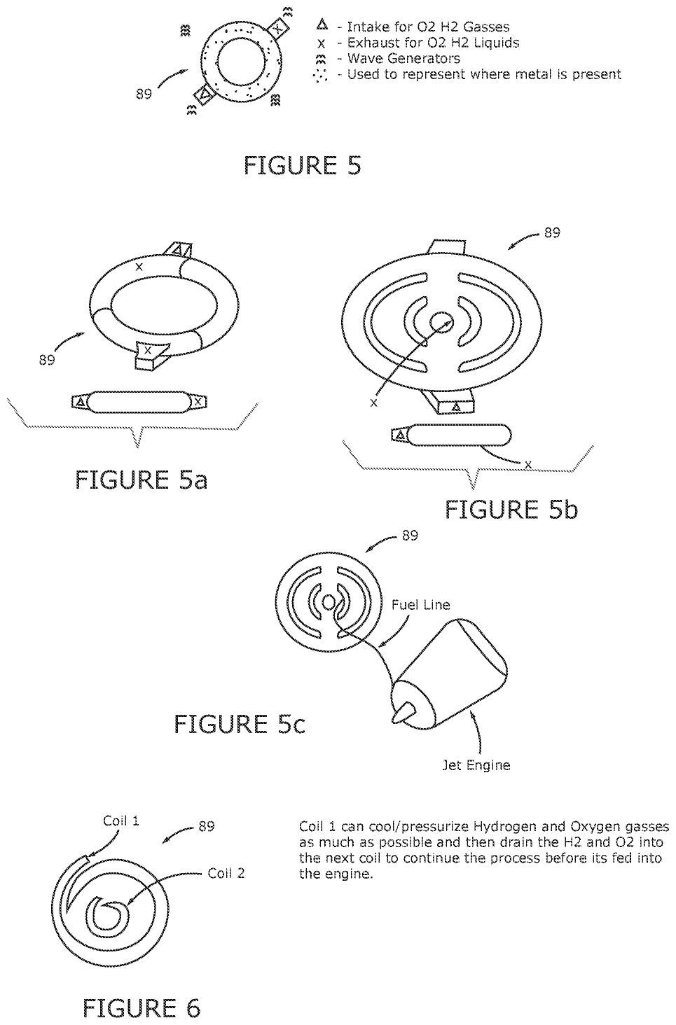

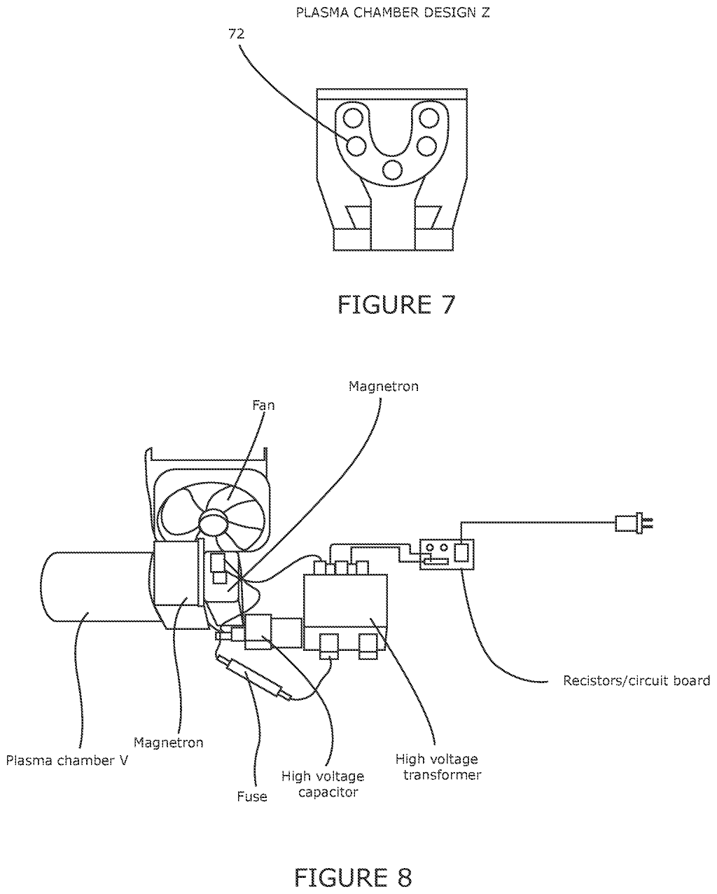

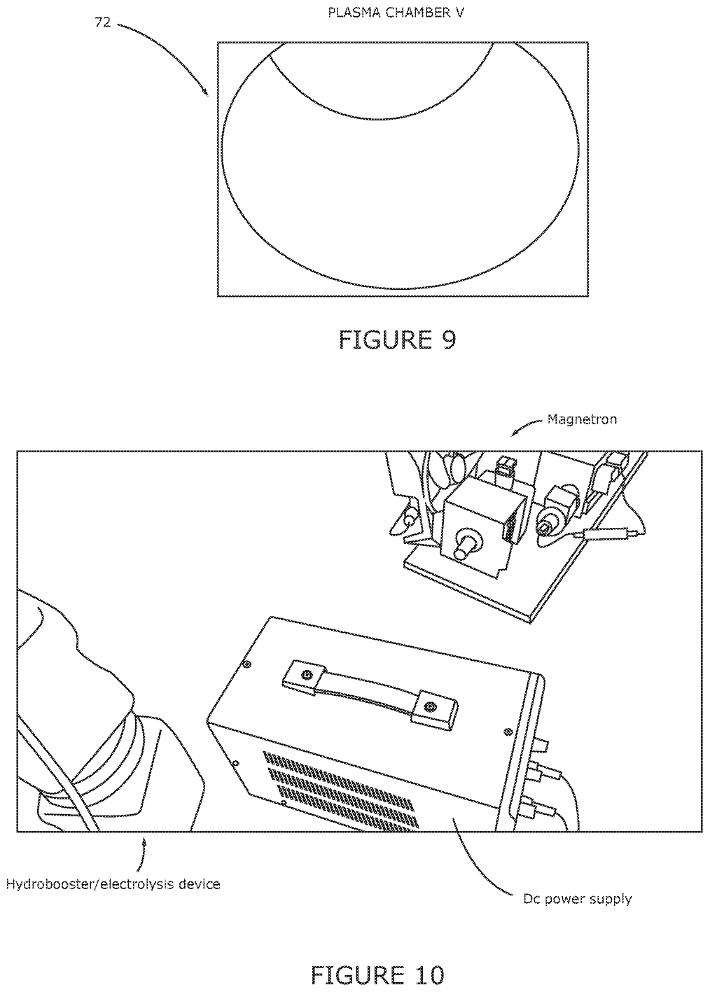

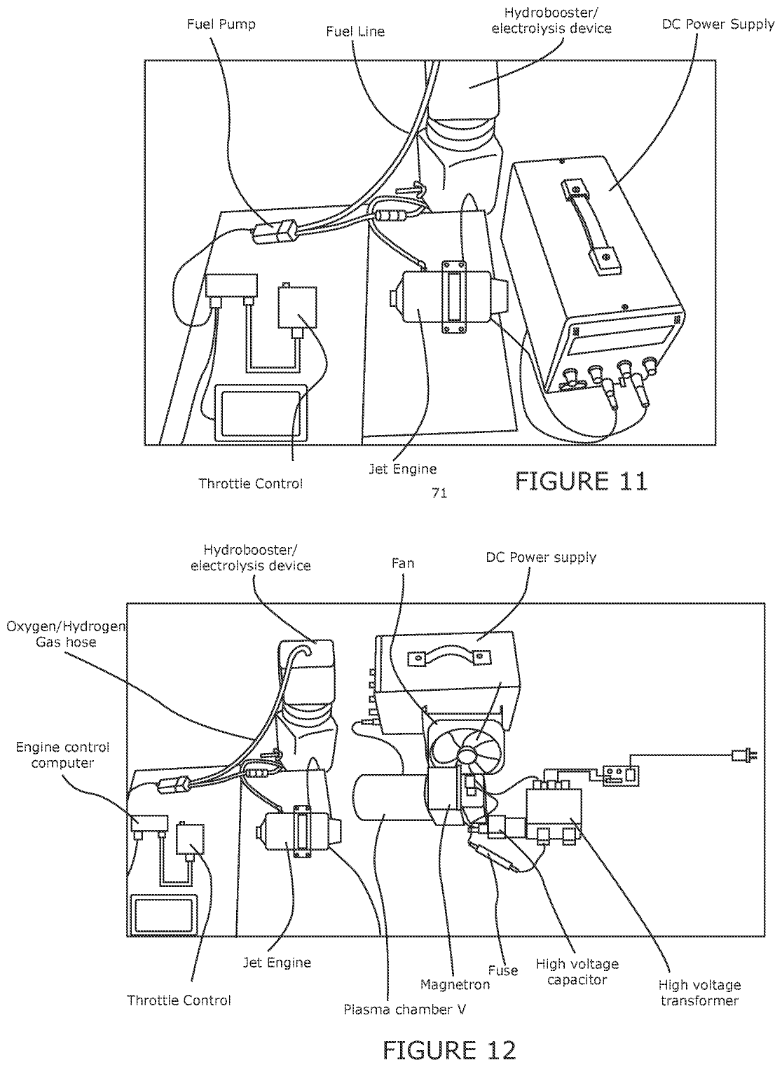

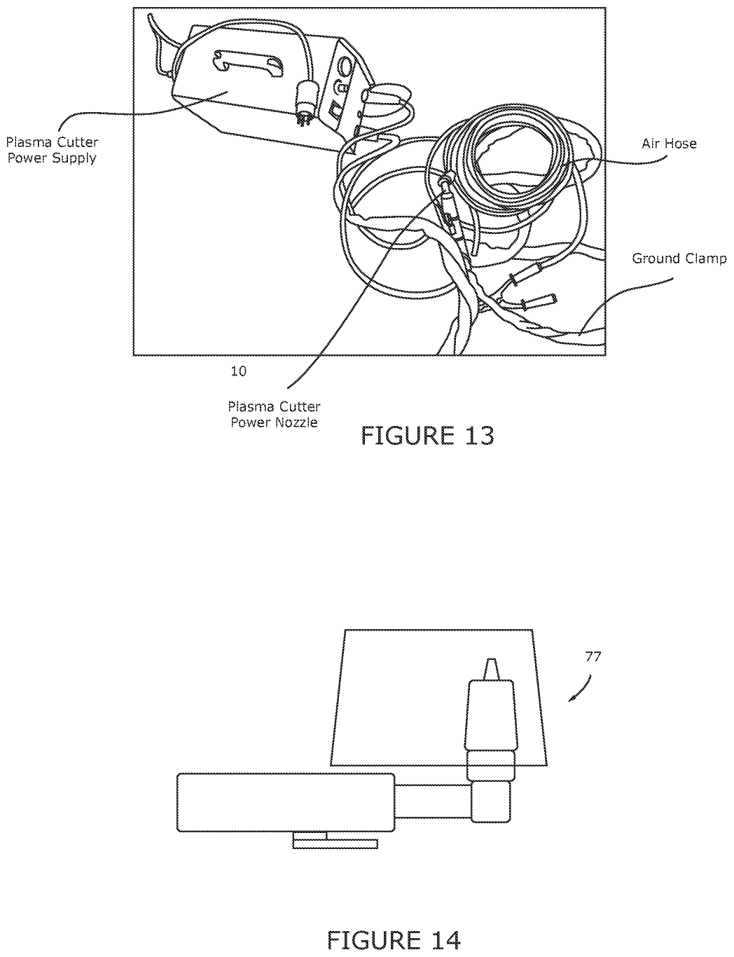

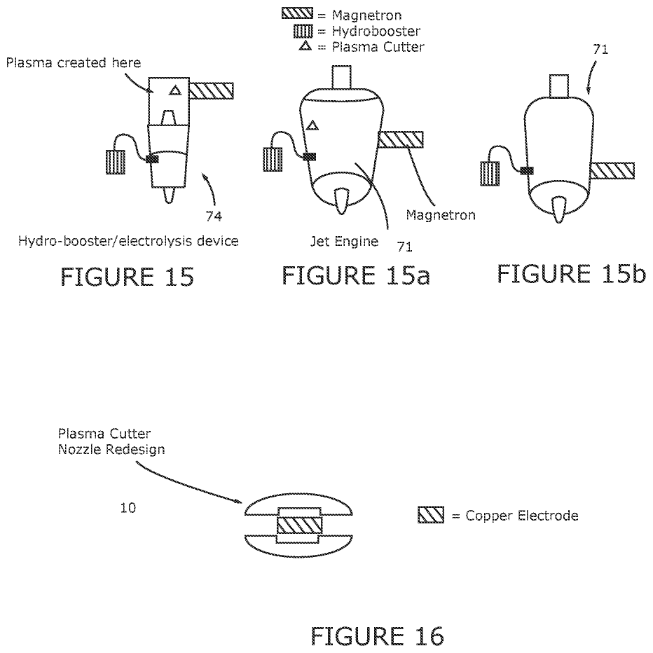

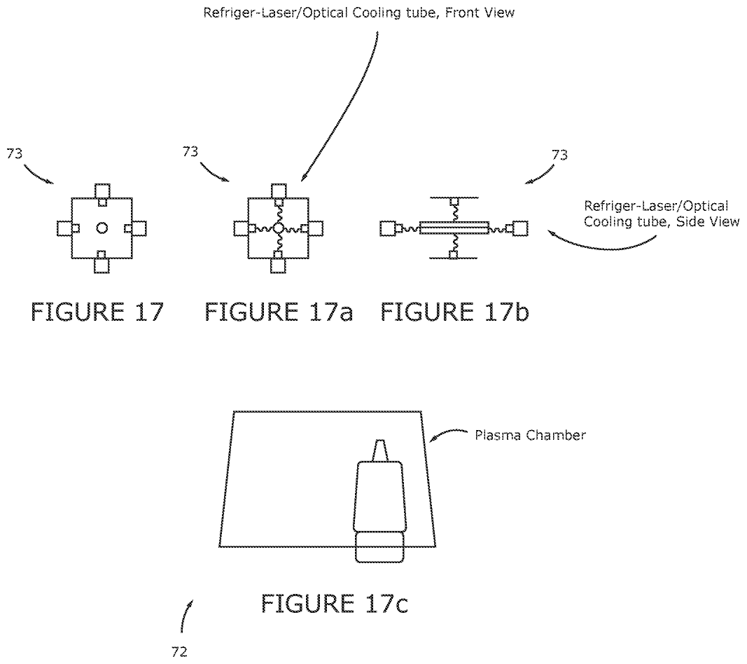

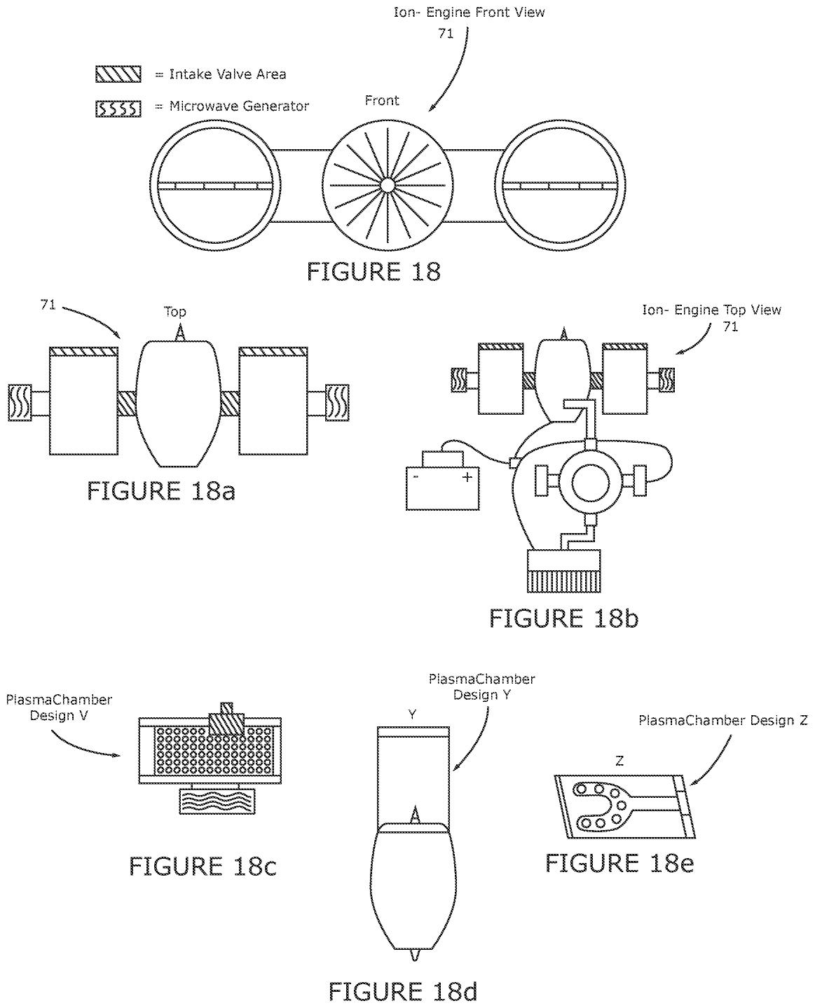

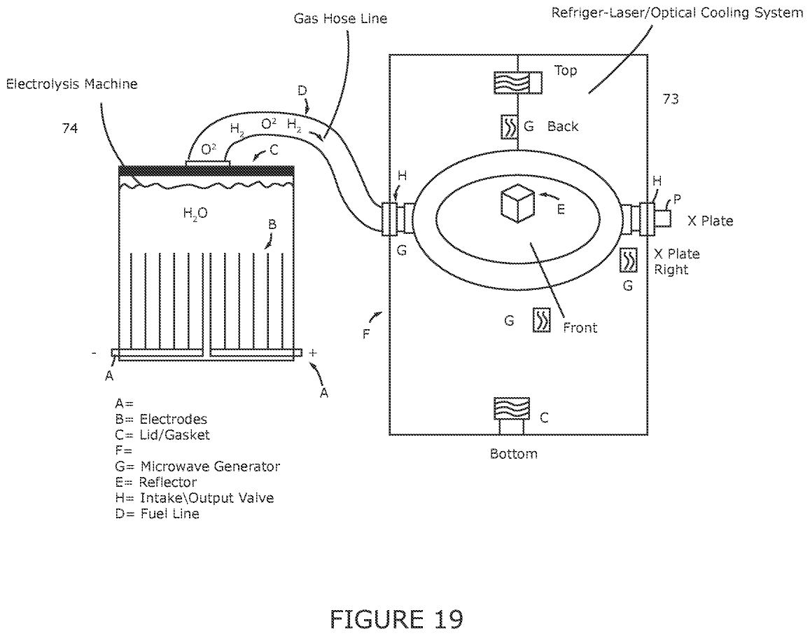

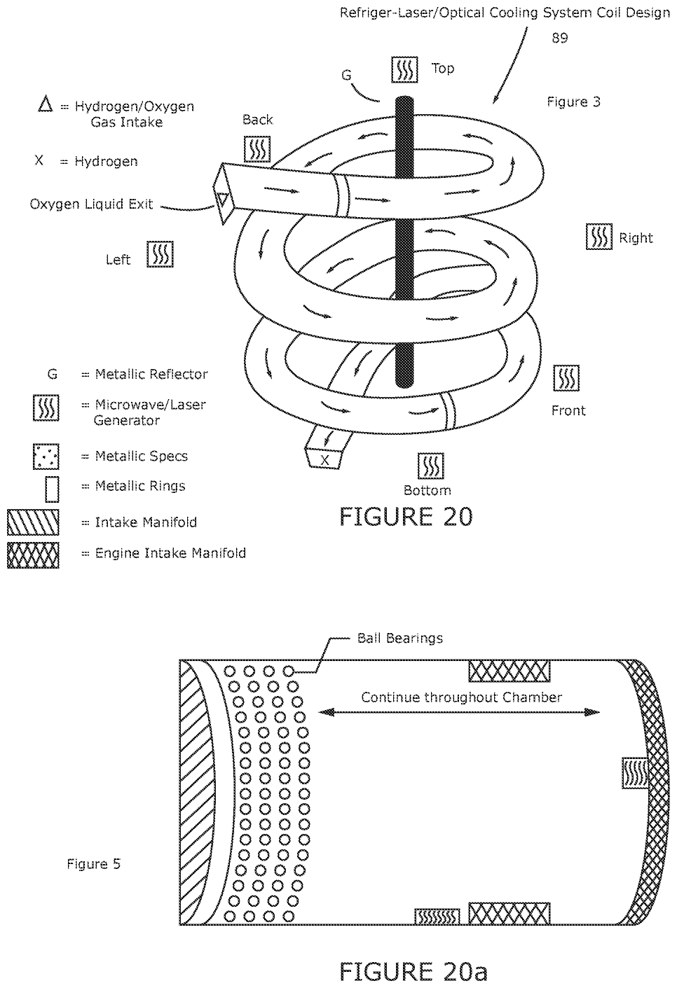

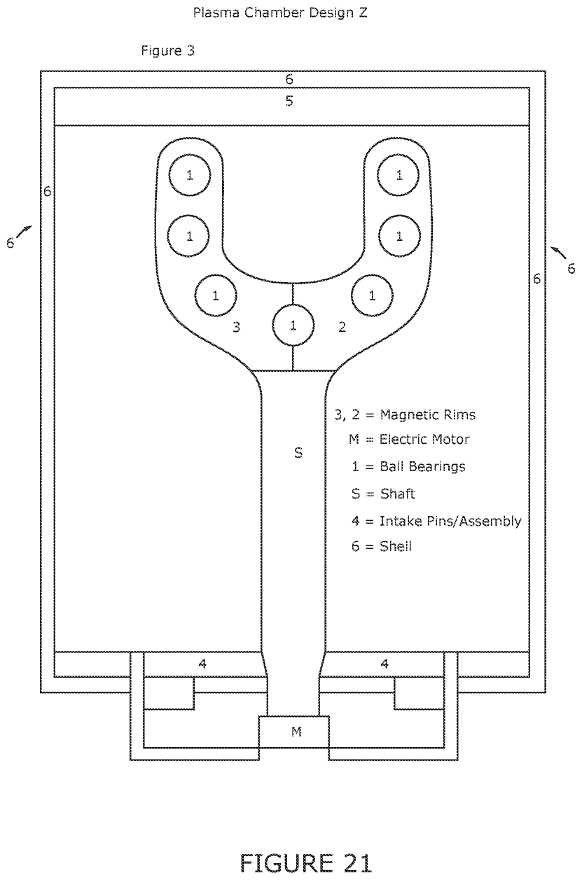

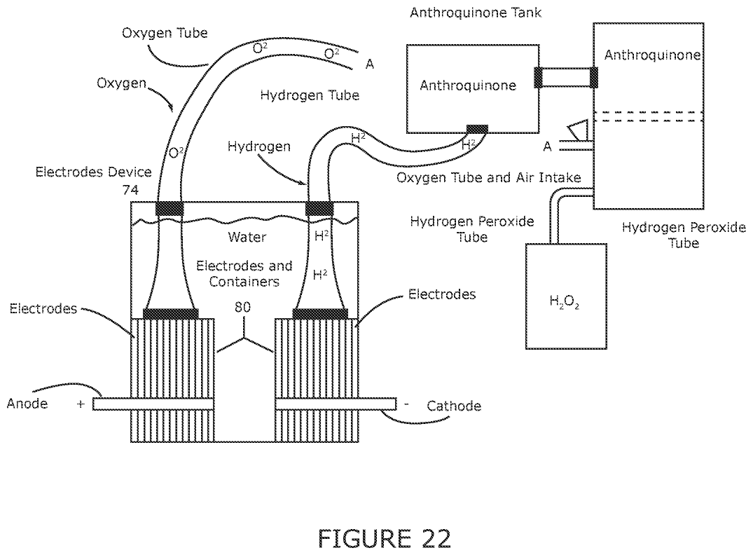

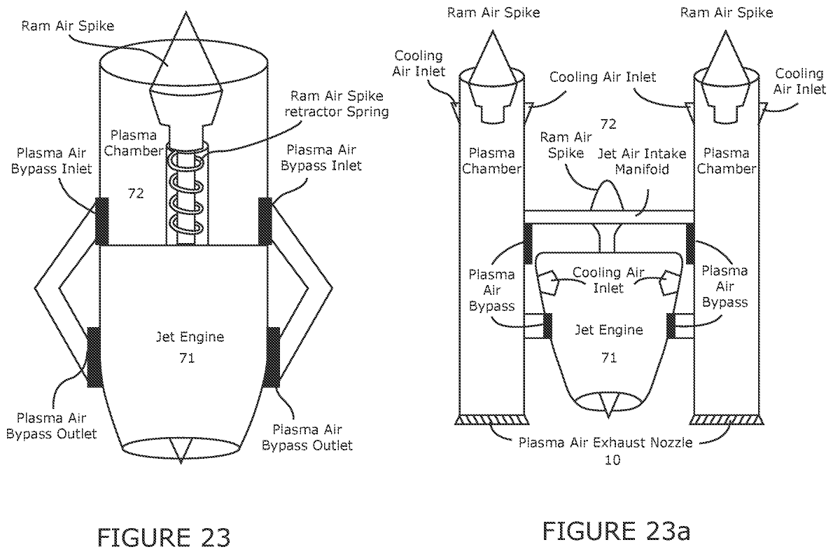

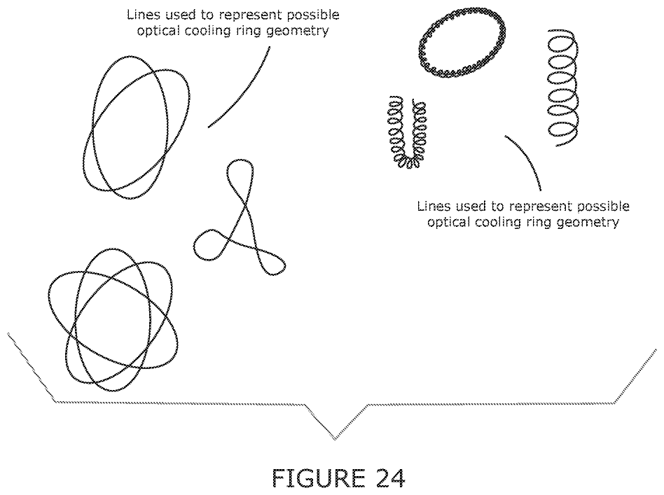

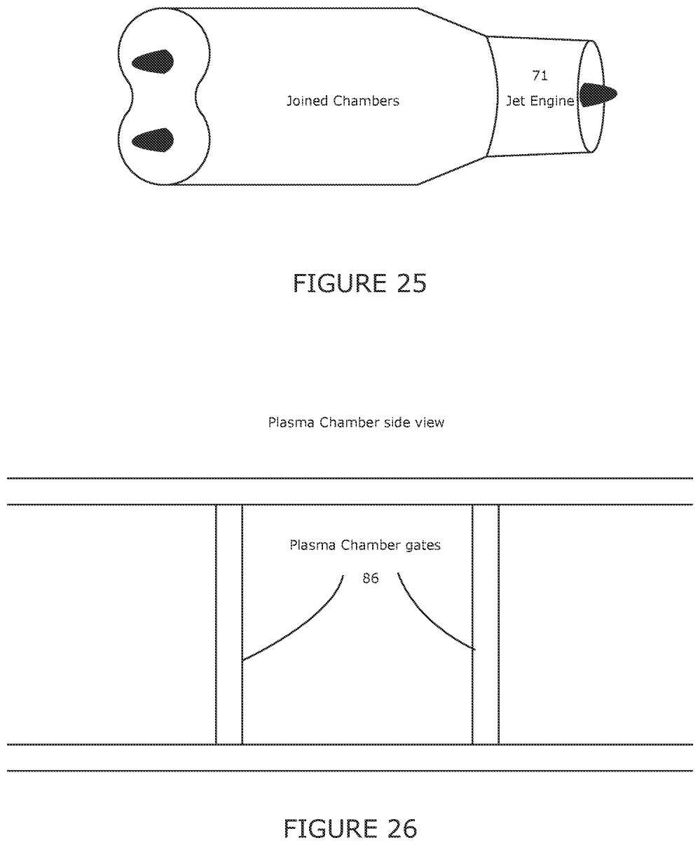

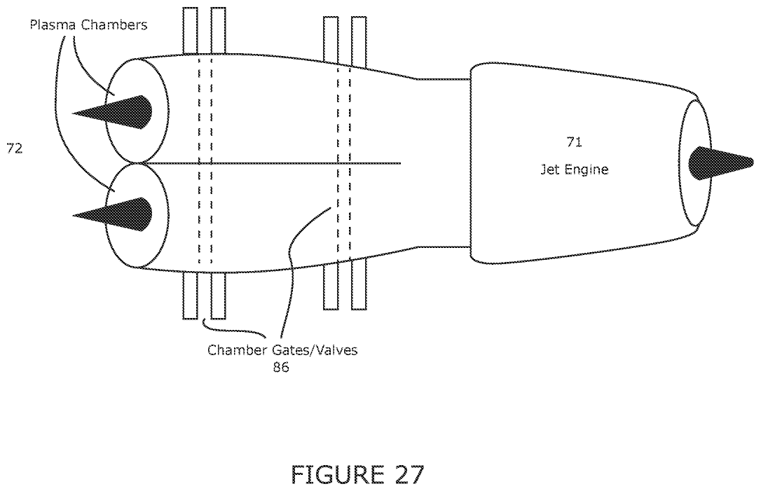

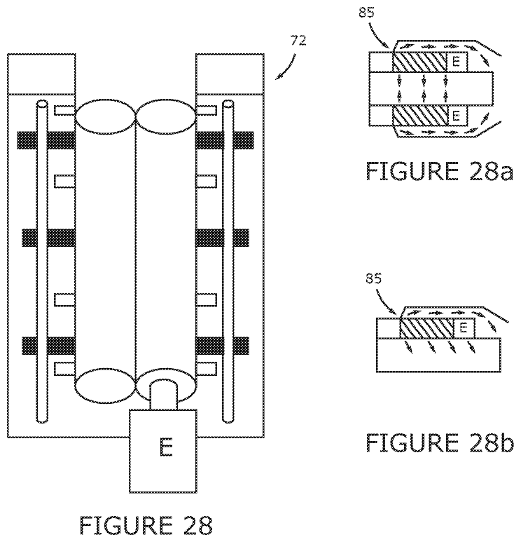

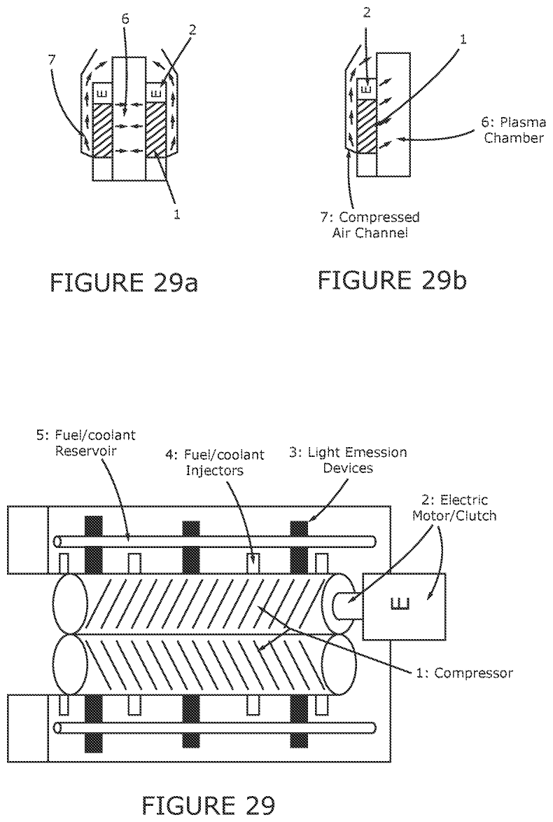

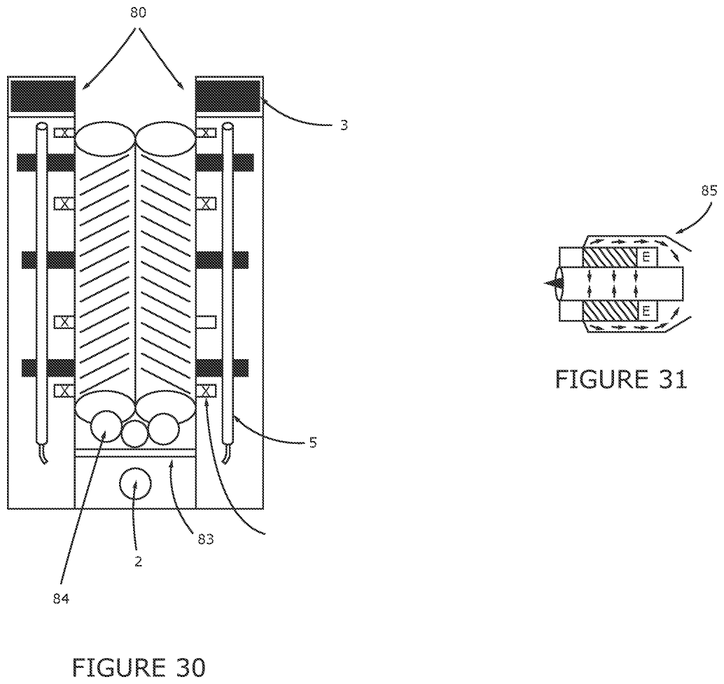

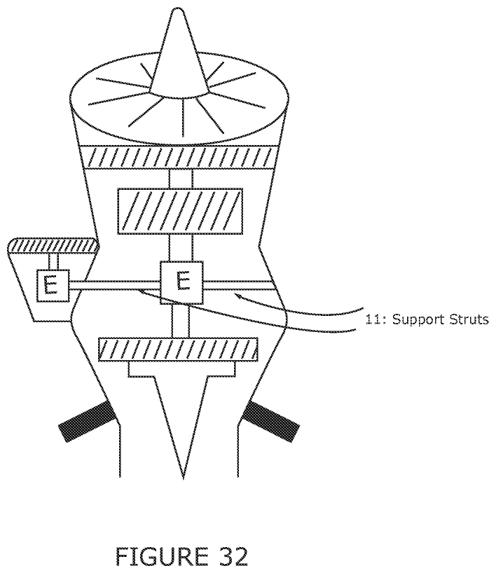

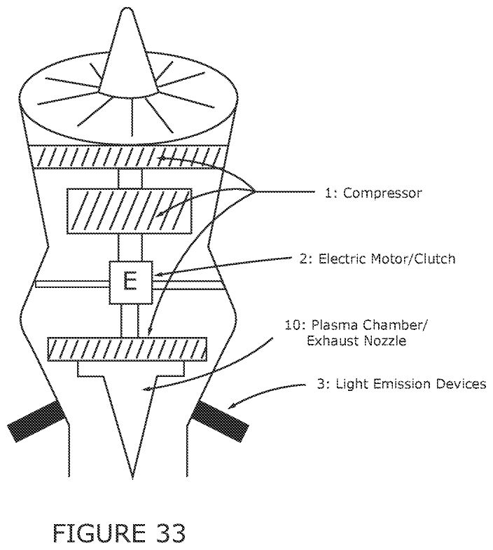

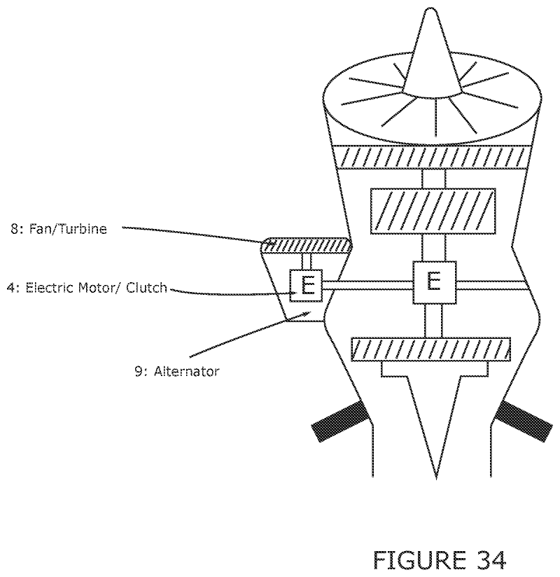

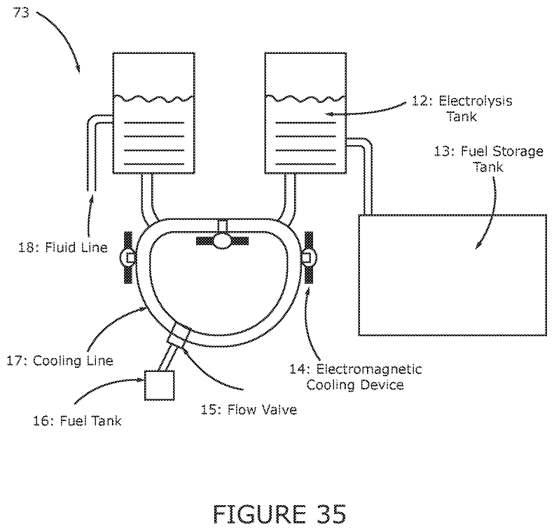

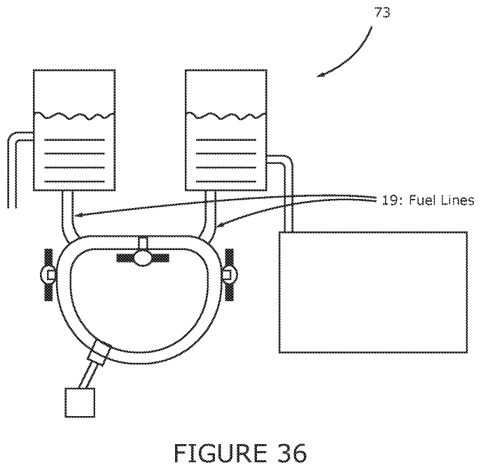

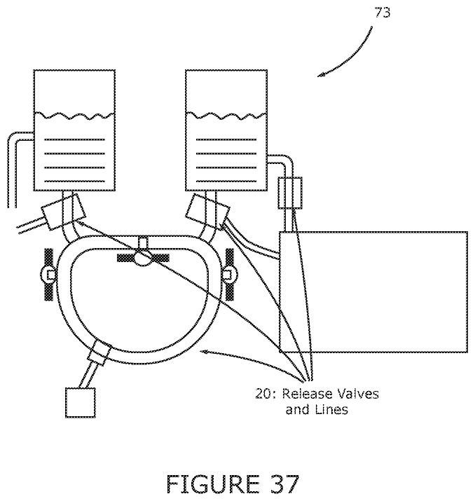

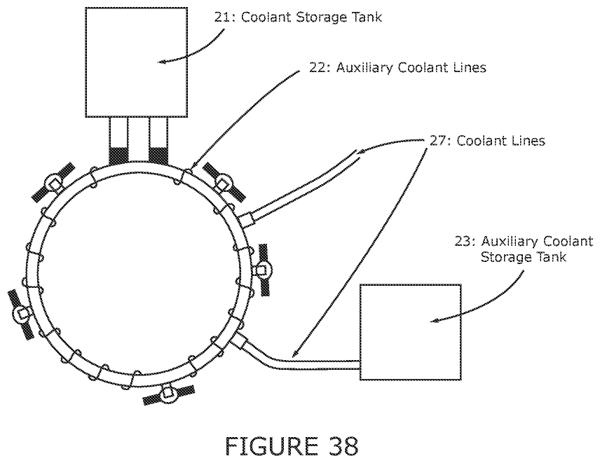

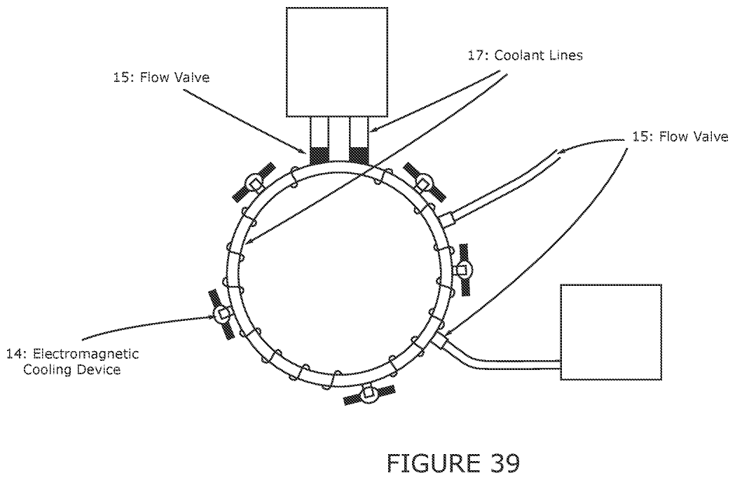

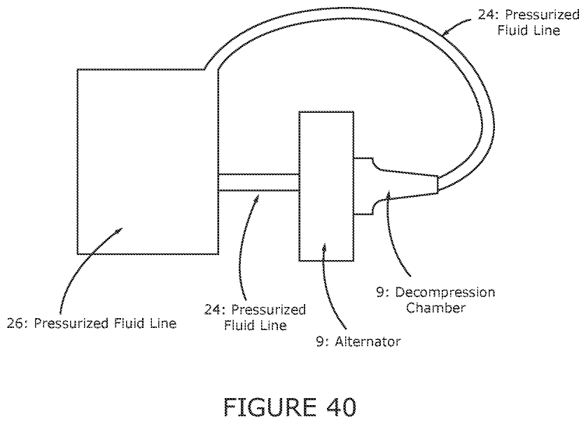

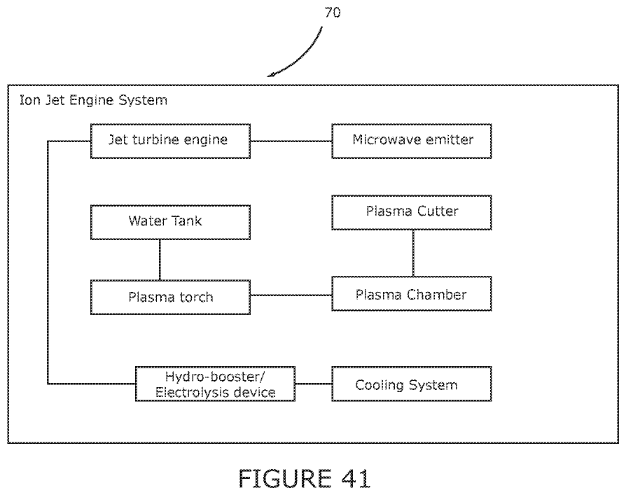

The non-limiting exemplary embodiment(s) is/are referred to generally in FIGS. 1-41 and is/are intended to provide an ion jet engine system 70 including a jet/ram engine 71, a chamber 72 for ionization of plasma, an assortment of charged turbine 8 blades/parts, a cooling system 73 using visible and non-visible light for cooling and/or heating intake gases, and fuel or engine components. An electrolysis machine 74 is also provided for converting water into its separate gases for use as coolant or fuel. Metal electrodes 80 may be provided to amplify light, and electromagnetic radiation aids with sustaining the engine's plasma thrust.

In a non-limiting exemplary embodiment, the engine 71 is able to utilize the air in the atmosphere for fuel to provide longer and near infinite flight times compared to conventional combustion ram/jet engines. Secondary fuel sources allow the engine to operate in space, and/or provide additional thrust. The cooling systems 73 allow the engine to operate at higher speeds without sustaining thermal damage, and for longer periods of time; allowing for greater fuel efficiency. The system 70 can be used as a hybrid engine, since it can run off of cryogenic hydrogen and oxygen fuels, or other rocket fuels and gases to allow for flight in or outside a planet's atmosphere. In addition, its light wave cooling methods assist in sustaining the operating temperature of the engine, or increase its performance by cooling fuel, parts or intake gases the engine takes in.

In a non-limiting exemplary embodiment, a plasma chamber 72 has an internal supercharger(s) 85. Such supercharger(s) 85 can be placed in a variety of positions on, in, or in front of the plasma chamber 72 to increase air flow into the engine. Supercharger 85 compressors 1 can be twin screw, roots, or blower design. An electric motor\clutch 2 helps spin the blades of the supercharger 85 and allows the supercharger 85 to disengage from the rest of the ion engines power train, which can be driven internally by the jet engine turbine shaft via a connecting drive passed through the inner turbine support struts 11. The electric motor/clutch 2 can rotate in reverse to act as a generator if needed. Light emission device(s) 3 are used to produce range of light from the spectrum (e.g., visible or non-visible light). Fuel\coolant injectors 4 are used to deliver coolant or fuel to wherever needed in the engine and may be applied as much or little as needed. Fuel\coolant reservoir 5 is used to store and control the flow of fluids into the engine bay, to increase power, efficiency, or regulate temperature. Many reservoirs 5, as needed, can be placed throughout the engine where necessary and have internal valves to help control flow. Plasma chamber 72 walls 6 can be lined with electrodes 80 and can have built-in channels 7 to bypass the flow of gases to other parts of the engine. Compressed air channels 7 can flow gases to other parts of the engine to increase efficiency.

In a non-limiting exemplary embodiment, an ion turbine engine can have an assortment of bypass channels 7 to direct or streamline air flow as needed. Fuel/coolant intakes can be place in-between any of the compressors and plasma chambers 72 for the desired effect. The walls of the engine can be lined with electrodes 80 and utilize light radiation from a broad spectrum range to help sustain ions \plasma during extended travel periods. Turbine compressors 1 can be charged to help sustain ion\plasma. Plasma chamber 72 exhaust nozzle 10 can be employed near an end of the engine, which can have walls lined with electrodes 80 as well as the center nozzle 10. Bypass channels 7 can be built into the nozzle 10 to allow flow of gases along the pointed tip, and a range of non-visible and visible light can be used to excite the gases flowing along the nozzle 10 and the walls to create plasma.

In a non-limiting exemplary embodiment, an alternator 9 can be an external system that is connected to the center shaft of the turbine 8 through the support struts 11 of the engine (i.e., through drive shafts, gears 84, bearings, and other mechanical components) to allow the alternator 9 to take rotational energy from the jet engines drive shaft to the electric motor 2 or generator. It can also have an opening and fan/turbine 8 to use incoming air to help turn the generator or relay compressed air through a bypass channel 7 to act as a turbo and transfer compressed air where needed in the engine.

In a non-limiting exemplary embodiment, the support struts 11 can be hollow and allow other components and systems to run inside it, or solid and support the internals of the engine. The internal electric motor\clutch 2 can be used to help drive the engine, or also act as an internal generator.

In a non-limiting exemplary embodiment, a fuel coolant system is shown wherein the dimensions and geometry are not to scale. Many of the parts and sub-assemblies can be used in different locations, and as many as needed. An electrolysis tank 12 is used for electrolysis on gases and liquids. A fluid storage tank 13 is used for the storage of gases and liquids. Electromagnetic cooling device 14 has a system of opposing light emission devices 3 on all three coordinate axes that can focus, or direct a range of visible, and non-visible light at a target. The system regulates the temperature of fuel as needed for the engine. Flow valve 15 can be used to release fuel out of the cooling system 73 based on the desired temperature. Fuel tank 16 is a storage tank for the cooled fuel. It can be bypassed to allow fuel to go directly to the fuel injection reservoir, or wherever as needed, in the engine. Cooling line 17 runs fuel by the electromagnetic cooling devices, to be cooled to the desired temperature. Fluid lines 24, 26 18 transport fluids from the fluid storage tank, electrolysis tank, or elsewhere to where they may be needed. Fuel lines 19 direct fluids from the electrolysis tank 12 to the coolant lines. Release valves and lines 20 release unwanted fluids/pressure anywhere internally or externally on the engine.

In a non-limiting exemplary embodiment, the coolant system 21 includes a coolant storage tank for containing necessary gases/liquids before entering the coolant lines. Any range of oils gases and liquids can be used, such as helium, carbon dioxide, nitrogen, freon, etc. The coolant storage tank can have direct contact with electromagnetic cooling devices for cooling, and\or feeding coolant to a closed coolant line loop. Auxiliary coolant lines 22 do not directly contact the electromagnetic cooling devices (ECDs), but rather regulate temperature through contact with the cooling lines. Such auxiliary coolant lines 22 can operate with the same or different fluids as the cooling lines, and can run through, around or by, engine parts that need thermal regulation. Auxiliary coolant lines 22 can pull fluids from the coolant tank, but mainly pull from the auxiliary coolant tank or not at all. Auxiliary coolant lines 22 can attach to bypass valves to release fluid if necessary.

In a non-limiting exemplary embodiment, auxiliary coolant storage tank 23 is capable of containing a range of coolant fluids (gases/liquids) but does not have a direct line to the ECD's and are thermally regulated by contact with coolant lines or auxiliary coolant lines. Coolant lines 17 can contact other parts of the engine as needed to regulate temperature but are primarily used to create a closed loop of coolant, for other sources to contact to regulate temperature from. Bypass valves can be used to release fluids as necessary internally or externally for the engine as needed.

In a non-limiting exemplary embodiment, a steam generator/boiler is used to collect heat from coolant line, auxiliary coolant lines, or direct contact from engine components. The heat is transferred to a fluid in a pressurized line or tank, and is forced to expand cool, and do work turning the alternator 9 to generate electricity, allowing the system to convert some waste heat back into electricity for the engine and batteries. A broad range of fluids can be used in the pressurized fluid lines 24, 26 for the desired effect and can be placed were ever as needed by the engine. Pressurized fluid lines 24, 26 are pressurized lines of fluids (liquids/gases). Decompression chamber 25 allows the pressurized fluid to decompress and expand to then do work. Alternator 9 works to generate electricity by being turned through the hot gases/liquids from the decompression chamber 25. Alternator 9 can use a series of tesla turbines or conventional turbines to help spin the alternator 9. Pressurized fluid tank 26 is used to store and collect pressurized fluids and heat.

It is noted that a broad used of metals, plastics, crystals, and alloys, etc. may be employed by the present disclosure.

Referring again to FIGS. 1-41 in general, in a non-limiting exemplary embodiment(s), the ion jet engine system 70 uses plasma from ionizing the air, and liquid hydrogen and/or oxygen from electrolyzing water to create thrust. The plasma can be started from a plasma cutter 77 or an arrangement of spheres that captures light and totally internally reflects the wave, creating resonate nodes inside the sphere; bringing the two in close contact to create an electro-magnetic field in the air between the spheres, ionizing it. Light, lasers, or microwaves will be used to sustain and expand the plasmas. Light, laser, or microwave cooling will be used to turn gases into liquids and to cool intake air and engine parts. The focus of the engine is to ionize the air compress and propel it through the engine to create thrust, with liquid hydrogen and oxygen being added as a booster.

In a non-limiting exemplary embodiment, different spectrums of light can be used to excite as many different molecules as possible or atoms that make up the air. The laser cooling system 73 includes blue shifting light to slow down the vibration of a target particle in all six directions, essentially cooling it and passing over the particle once it is at the desired temp as to not heat it back up again. The idea is to either cool a metal fuel injector 4, coolant tube, or gas, right before the hydrogen and oxygen reaches the engine; to maximize power and make the system a lot safer, as the highly combustible fuel is only volatile right before it enters the engine.

Advantageously, in a non-limiting exemplary embodiment, two ideas for transferring the plasma from the chamber 72 to the engine are: 1.) to have one or two chambers 72 that independently control the flow of intake air and plasma creation, and 2.) to connect the chamber 72 directly to the engine and try to ionize the air as fast as possible before it enters the engine.

In a non-limiting exemplary embodiment, the benefits of the first configuration are that is allows the chamber 72 to build up a more powerful plasma with microwaves, before it enters the compression and expulsion of the jet engine. The second configuration rams air as fast as the engine could accelerate but may only work at much higher speeds.

In a non-limiting exemplary embodiment, the essential parts include: 1.) jet turbine engine 71, high voltage turbine 8 blades; 2.) microwave emitter 76; 3.) tank of water 78, with built-in stainless steel plates 80, for electrolysis; and 4.) plasma torch 79, plasma chamber 72, 1.2 cm diameter spheres that trap and internally reflect microwaves. The advantages of this ion jet engine system 70 is that it can compress, and blast air with greater thrust then other ion engines, and uses ionized air as the primary fuel, giving it an almost unlimited flight time. With the added boost from the electrolysis of water, and the cooling of both intake air, and the hydrogen and oxygen gases, it maximizes thrust using a jet turbine/ram jet design 71; uses the air as a near unlimited fuel and cooled hydrogen and oxygen gases as a booster.

In a non-limiting exemplary embodiment, the ion jet engine system 70 includes a jet engine 71 (ram engine), charged turbine 8 blades/parts, a freeze ray or blue shifted light to slowdown atoms (Mazer's lasers), a system of stainless steel and graphite for electrolysis, and a plasma chamber 72 (internal refracting spheres used to trap light and focus their electromagnetic fields in between them). It uses light and/or laser cooling for improved fuel efficiency and to cool the engine. It can be used as a hybrid for atmospheric, and deep space flight by using rocket fuel, or ionized gases for thrust. It uses the air as the primary fuel, but can be used as a hybrid engine, since it can run off of hydrogen and oxygen (e.g., rocket fuel). Also, like a deep space ion engine, can use auxiliary gases like argon, or any other gas for ionic propulsion. The system can cool the intake air, or second fuel, and even other parts of the engine.

In a non-limiting exemplary embodiment, the plasma can be started from a plasma cutter 77 or an arrangement of glass, metal, gel, and/or spheres that create a high intensity charge in the air between them. Microwaves is used to excite and sustain the plasma also helping the gas expand rapidly. Microwaves that have their wavelength extended are used to cool down the gases. By either creating a standing wave in six directions, or masers (e.g., device that produces coherent electromagnetic waves through amplification by stimulated emission) to cause atoms of air to blue shift only when moving towards the microwave radiation and stopping and letting the photon pass through it; once it is stopped in that direction causing the gases to cool. This will be applied to both the intake air, and the hydrogen and oxygen gases. A different wave may be used to better effect other elements in the air, or to a greater extent, as needed.

In a non-limiting exemplary embodiment, any form of light and electron stimulus devices or technology can be used to create light, lasers, and masers, and can be used interchangeably or in conjunction where light, lasers, and masers are used (e.g., klystrons, magnetrons ruby cathodes, diodes, semi-conductors, transistors, etc.)

In a non-limiting exemplary embodiment, the ion jet engine system 70 can be set up in three ways: 1.) plasma chamber 72 in front of the jet engine that creates a plasma that then gets sucked into the engine, compressed, and thrusted out with the charged turbine 8 blades; 2.) a standing wave of microwaves, and/or a high voltage charge and/or spark will create the plasma in the interior of the engine; 3.) The microwave system, plasma torch 79, and high-voltage interior will be inserted right where the fuel injectors 4 are or aimed from the back of the engine.

In a non-limiting exemplary embodiment, the plasma chamber 72 can be equipped with a nozzle 10 in the rear for ejecting plasma as thrust, under intense pressures, if needed.

In a non-limiting exemplary embodiment, the plasma chamber 72 for the engine can be joined together at the base or intake for the jet turbine, or along the center, and multiple chambers 72 can be combined together. The internal structure of the plasma chamber 72 may be sectioned by gates 86 and/or valves 83 to help regulate pressure. The sections can close off to only intake air, and open once the right heat and compression levels are reached before ejecting the gases into the jet engine. The gates 86 can work like a carbonator or be pulled from left to right or up or down within the chamber 72 to control air flow.

In a non-limiting exemplary embodiment, a compressor 1 (e.g., supercharger 85, turbo, blower, air compressor, etc.) can be used in conjunction with the plasma chambers 72 to help build pressure needed for the engine.

In a non-limiting exemplary embodiment, the ion jet engine system 70 should just require a battery and/or water for initial startup and use the air as the primary fuel. The turbine 8 blades could even be replaced with a single cathode, anode design like one giant plasma torch 79, and integrate the systems stated above to improve performance.

In a non-limiting exemplary embodiment, the LOX injector (oxidizer injector) through which the liquid oxygen is directed in route to the injector for the jet engine, would be to design the coolant tubes out of plastic with a doughnut shape, with intake and exhaust valves for oxygen and hydrogen. The plastic will have metal specks, rings, or chunks of metal built into it for the microwave to couple with, and only with the metal, passing through the plastic without heating it. The metals built into the plastic tubes will then cool the plastics which will cool the air inside the tubes.

In a non-limiting exemplary embodiment, the spherical shape of the tube can allow microwave sources to easily access the metals on from all six sides. There can also be multiple loops of tubing to separate gases and liquids and giving the gases more length of tube to cool. The cooling loop can be sectioned off so that liquids will flow into farther, separate parts and/or loops of the system, allowing for the relatively warmer gases to cool without disrupting the temperature of the already cooler liquids.

In a non-limiting exemplary embodiment, the microwave system can be set up to allow the wave to hit metals in sequence, so once it slows one metal atom to a stop, when it passes over it will hit the next behind it and cool it down, repeating the process and reflecting back the other way to do it again. The metals may also be quantumly entangled to increase the effect with less effort from the microwave.

In a non-limiting exemplary embodiment, the cooling tubes can be coiled, and the coils 89 stacked on top of, or in one another, where the first coil 89 feeds into the secondary one, and preferably pump cooler liquids into the secondary coil 89 to separate them from the hotter gases in the primary coil 89.

In a non-limiting exemplary embodiment, the coil 89s can also be pressurized to help cool the gases and/or liquids.

In a non-limiting exemplary embodiment, the metals in the tubes can be polarized to allow for less directions that the microwave system has to cool, and even be quantumly entangled to reduce the work needed from the microwave system.

In a non-limiting exemplary embodiment, the microwave rays or the freeze rays can be modified so that after cooling and passing over one metal atom, it will run into the next right after it, continuing this process and reflecting back from walls of the cooling tubes to start over again.

Referring to FIG. 21, in a non-limiting exemplary embodiment, the plasma injector and/or chamber 72 will be used to generate plasmas and funnel them down into the jet engine, parts 3 and 2 can be magnetized to help create a vortex and suck the plasma down the chamber 72, where parts 4 will pull back to the outer chamber 72 allowing the plasma to flow into the engine at the desired temperature. Parts #1 will be metallic spheres that will absorb microwave energy and/or other light energy, concentrate, and discharge an electro-magnetic field to increase the intensity of the plasma. The walls 6 of the chamber can be positive or negative charged to assist in flow or powering the plasma. Part 5 is where the intake valve will go. Most of the walls of ion jet engine system 70 and plasma injector and/or chambers 72 will be charged to assist in flow and power of the plasma.

In a non-limiting exemplary embodiment, another material that can be utilized for optical cooling for the microwave or lower light spectrum is beryllium oxide, hydrogen gas, or ammonia gas.

In a non-limiting exemplary embodiment, another fuel type that can be utilized in the engine can be hydrogen peroxide (H2O2), in varying concentrations; a silver catalyst can be utilized to help with the combustion of the fuel and can be place in multiple locations in the engine (e.g., on the glow plug around or near the fuel injector or even lining the walls of the engine itself).

In a non-limiting exemplary embodiment, the cooling system 73 can have any number of rings, coil 89s, or surface area necessary to facilitate cooling.

In a non-limiting exemplary embodiment, the electrolysis device 74 can also be used to produce concentrated amounts of hydrogen peroxide. A second container of anthraquinone can be introduce to the hydrogen given off and cycled into a second container of air and oxygen rich water to produce concentrated amounts of H₂O₂. The H₂O₂ produced can be cooled by the optical cooling system 73 or pumped directly into the engine for thrust.

In a non-limiting exemplary embodiment, the water tank 78 and systems can also be used as a hydrogen battery as well, aiding the solid metal battery (e.g., LiPo, or NiMH based) and create H₂O₂ if necessary, and perform its normal duties as the hydro-booster, creating LOx for the jet engine 71.

In a non-limiting exemplary embodiment, tesla valve airfoils, vortexes, and non-laminar air flow, can be used to slow down or speed up the travel of all fluids (e.g., gas or liquid), especially for intake and exhaust uses. Door bypasses, and cones can be used in the design of the engine to manipulate pressure flowing through the turbine 8 and maximize efficiency for thrust.

In a non-limiting exemplary embodiment, multiple materials can be used for the cathodes and anodes (e.g., graphite graphene, steel, copper, platinum, etc.).

In a non-limiting exemplary embodiment, wherein the plasma chamber 72 includes a cooling system 73 having a shifting light and a target particle, wherein the cooling system 73 is configured to slow down vibration of the target particle in six directions, thereby cooling the target particle and passing over the target particle once the target particle is at a desired temp as to not heat up the target particle back again.

In a non-limiting exemplary embodiment, wherein the cooling system 73 further includes a metal fuel injector, a coolant tube, or a gas; wherein the cooling system 73 is configured to either cool the metal fuel injector, the coolant tube, or the gas right before hydrogen and oxygen reaches the jet turbine engine 71, wherein the cooling system 73 is further configured to increase power because the highly combustible fuel is only volatile right before it enters the jet turbine engine 71.

In a non-limiting exemplary embodiment, the shifting light includes a blue shifting light.

In a non-limiting exemplary embodiment, wherein the shifting light includes a variety of different light spectrums to excite different molecules or atoms that make up the target particle.

In a non-limiting exemplary embodiment, further includes a plasma cutter 77 and an arrangement of spheres configured to capture light and totally internally reflects light wave, creating resonate nodes inside the arrangement of spheres bringing two spheres of the arrangement of spheres in close contact to create an electro-magnetic field in the air between the two spheres, thereby ionizing the two spheres; wherein the plasma chamber 72 is further configured to use a large range of light spectrum to sustain and expand plasma. The plasma cutter 77 is configured to use a large range of light spectrum to turn gases into liquids and to cool intake air and the jet turbine engine 71. The jet turbine engine 71 is configured to ionize and propel compressed air through the jet turbine engine 71 to create thrust, with the liquid hydrogen and the liquid oxygen being added as a booster.

While various embodiments have been described, the description is intended to be exemplary, rather than limiting, and it is understood that many more embodiments and implementations are possible that are within the scope of the embodiments. Although many possible combinations of features are shown in the accompanying figures and discussed in this detailed description, many other combinations of the disclosed features are possible. Any feature of any embodiment may be used in combination with or substituted for any other feature or element in any other embodiment unless specifically restricted. Therefore, it will be understood that any of the features shown and/or discussed in the present disclosure may be implemented together in any suitable combination. Accordingly, the embodiments are not to be restricted except in light of the attached claims and their equivalents. Also, various modifications and changes may be made within the scope of the attached claims.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

The scope of protection is limited solely by the claims that now follow. That scope is intended and should be interpreted to be as broad as is consistent with the ordinary meaning of the language that is used in the claims when interpreted in light of this specification and the prosecution history that follows and to encompass all structural and functional equivalents. Notwithstanding, none of the claims are intended to embrace subject matter that fails to satisfy the requirement of Sections 101, 102, or 103 of the Patent Act, nor should they be interpreted in such a way. Any unintended embracement of such subject matter is hereby disclaimed.

Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various examples for the purpose of streamlining the disclosure. This method of disclosure is not to be interpreted as reflecting an intention that the claims require more features than are expressly recited in each claim. Rather, as the following claims reflect, inventive subject matter lies in less than all features of a single disclosed example. Thus, the following claims are hereby incorporated into the Detailed Description, with each claim standing on its own as a separately claimed subject matter.

What is claimed as new and what is desired to secure by Letters Patent of the United States is:

1. An ion jet engine system comprising:
a jet turbine engine having at least one high voltage turbine blade;
a microwave emitter in communication with said jet turbine engine;
a water tank having stainless steel plates for providing fluid and being in communication with said jet turbine engine;
a plasma torch in communication with said water tank; and
a plasma chamber in communication with said plasma torch and having diameter spheres that trap and internally reflect microwaves;
wherein said jet turbine engine is configured to use plasma generated from ionizing air and liquid hydrogen and/or liquid oxygen from electrolyzing water to create thrust.

2. The ion jet engine of claim 1, wherein said plasma chamber comprises: a cooling system having a shifting light and a target particle, wherein said cooling system is configured to slow down vibration of said target particle in six directions, thereby cooling said target particle and passing over said target particle once said target particle is at a desired temp as to not heat up said target particle back again.

3. The ion jet engine of claim 2, wherein said cooling system further comprises: a metal fuel injector, a coolant tube, or a gas;
wherein said cooling system is configured to either cool said metal fuel injector, said coolant tube, or said gas right before hydrogen and oxygen reaches said jet turbine engine, wherein said cooling system is further configured to increase power because the highly combustible fuel is only volatile right before it enters said jet turbine engine.

4. The ion jet engine of claim 3, wherein said shifting light comprises: a blue shifting light.

5. The ion jet engine of claim 3, wherein said shifting light comprises: a variety of different light spectrums to excite different molecules or atoms that make up said target particle.

6. The ion jet engine of claim 3, further comprising:
a plasma cutter; and
an arrangement of spheres configured to capture light and totally internally reflects light wave, creating resonate nodes inside said arrangement of spheres bringing two spheres of said arrangement of spheres in close contact to create an electro-magnetic field in the air between said two spheres, thereby ionizing said two spheres;
wherein said plasma chamber is further configured to use a large range of light spectrum to sustain and expand plasma;
wherein said plasma cutter is configured to use a large range of light spectrum to turn gases into liquids and to cool intake air and said jet turbine engine;
wherein said jet turbine engine is configured to ionize and propel compressed air through said jet turbine engine to create thrust, with said liquid hydrogen and said liquid oxygen being added as a booster.
